(19) United States
(12) Patent Application Publication
(10) Pub. No.: US 2024/0146834 A1
(43) Pub. Date: May 2, 2024

(54) Baby Teether Phone Case

(71) Applicant: Sabrina Reilly, Dover, NJ (US)

(72) Inventor: Sabrina Reilly, Dover, NJ (US)

(21) Appl. No.: 17/979,157

(22) Filed: Nov. 2, 2022

(51) Int. Cl. H04M 1/04; A61J 17/02; H04B 1/3888

(52) U.S. Cl. CPC H04M 1/04; A61J 17/02; H04B 1/3888

(57) ABSTRACT

The Hello Biters is the only product of its kind that is specifically developed to offer a safe way for a child to chew on a mobile device without harming themselves or damaging the device. This unprecedented product is uniquely designed with a tight waterproof clip to protect the charging port, rubber parts able to sustain biting activities, and a waterproof phone case that can be easily sanitized and cleaned, at the user's preference.

### BACKGROUND

Parents and/or caregivers may often find themselves constantly rescuing their phones from the teething mouth of their toddlers. Not only can the residual spit and drool lead to phone damage, but mobile phones tend to be covered in germs, which can pose significant health issues. There have been no products available as original equipment or as an aftermarket to address this problem.

An apparatus that is fun and entertaining for toddlers that also protects parents phones from damage from the toddler is not being met by any known device or system at present. There have been no products available as original equipment or as an aftermarket to address this problem either.

### SUMMARY OF THE INVENTION

The main purpose of the baby teether phone case is to provide users with a multi-functional phone case that can also be used as a teether for small children/babies.

A cell phone case device including a cell phone case comprising a back, a front for a cell phone screen, two sides and two ends, a three-dimensional figure disposed on the back of the cell phone case configured to provide a child chewable and an absorber to a drop shock on the back, a three-dimensional pair of side appendages connected to the three-dimensional figure to provide a child chewable and an absorber to a drop shock on the sides and a three-dimensional pair of end appendages connected to the three-dimensional figure to provide a child chewable and an absorber to a drop shock on the ends.

### BRIEF DESCRIPTION OF THE DRAWINGS

FIG. 1 is a back elevational view of the baby bear teether phone case in accordance with an embodiment of the present disclosure.

FIG. 2 is a front elevational view of the baby bear teether phone case in accordance with an embodiment of the present disclosure.

FIG. 3 is a back elevational view of the baby butterfly teether phone case in accordance with an embodiment of the present disclosure.

FIG. 4 is a front elevational view of the baby butterfly teether phone case in accordance with an embodiment of the present disclosure.

FIG. 5 is a side view of the baby bear teether phone case in accordance with an embodiment of the present disclosure.

FIG. 6 is an end view of the baby bear teether phone case in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

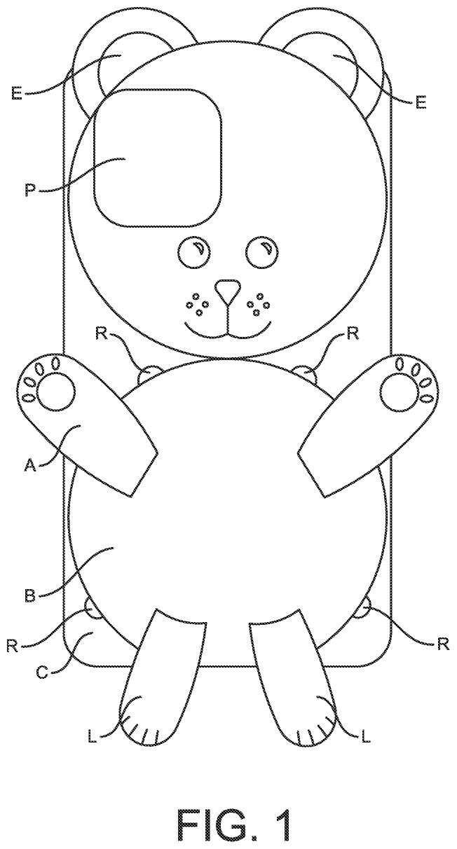

FIG. 1 is a back elevational view of the baby bear teether phone case showing: a safe chewable rubber three-dimensional figure B attached to a cell phone case C with movable flapping arms referenced as A, safe chewable rubber legs L and ears E off thick body part referenced as B, wherein the case C is water proof, chew safe, easy sanitized water tight phone case, in accordance with an embodiment of the present disclosure. A camera opening P is also defined in the cell phone case C. Retaining bosses R enable a removeable or popping detachment of the figure from the cell phone case.

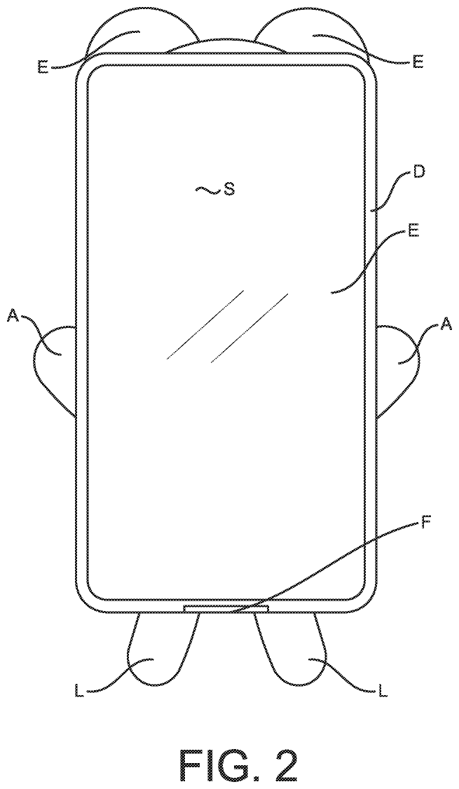

FIG. 2 is a front elevational view of the baby bear teether phone case showing: arm appendages A, tight seal front overlap of the cell phone case C to a cell phone screen S referenced as D, ear appendages E, leg appendages L, and a tight waterproof clip to protect charging port referenced as F, in accordance with an embodiment of the present disclosure.

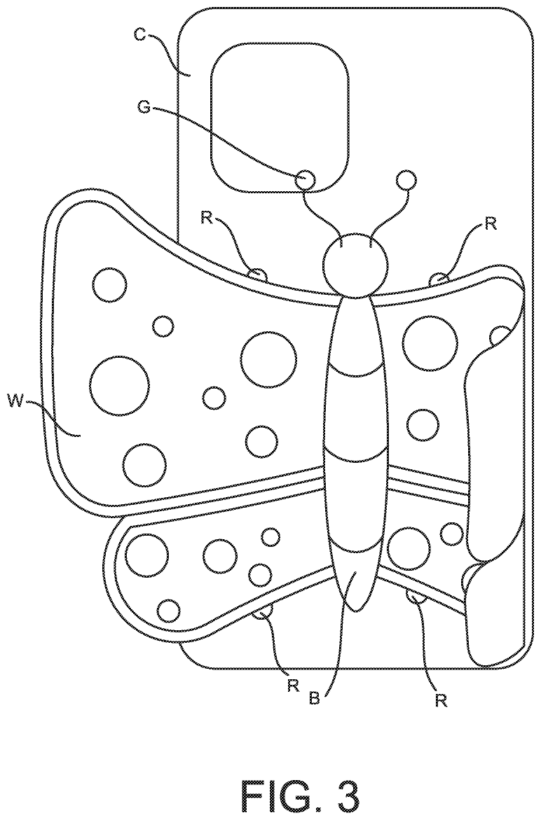

FIG. 3 is a back elevational view of the baby butterfly teether phone case showing: safe chewable rubber movable flapping arms wings referenced as W, safe chewable rubber pops off thick body part referenced as B, movable biteable rubber antenna referenced as G, and retaining bosses R in accordance with an embodiment of the present disclosure.

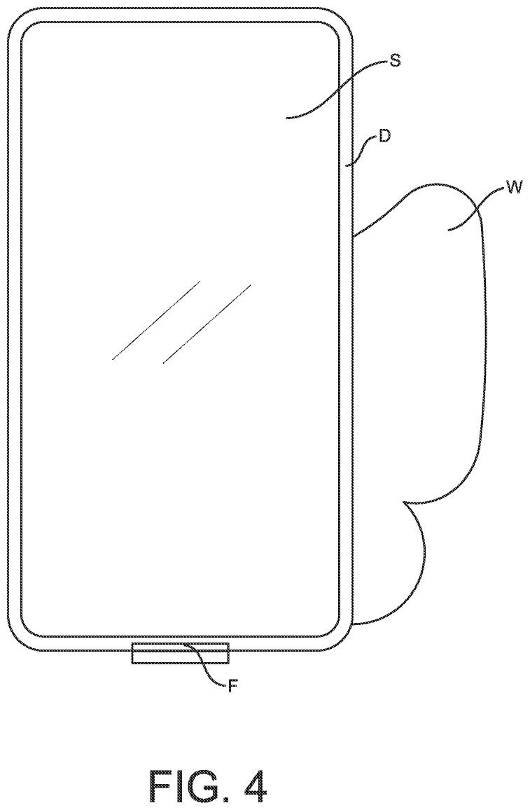

FIG. 4 is a front elevational view of the baby butterfly teether phone case showing: tight waterproof clip to protect charging port referenced as F, screen S, wrap around wing W and tight seal D in accordance with an embodiment of the present disclosure. The wrap around wing W as an appendage can serve both a side and an end and even three-dimensional chewing and shock absorbing to the front screen side S depending on its size and orientation.

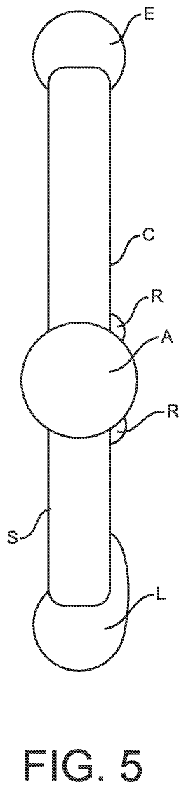

FIG. 5 is a side view of the baby bear teether phone case in accordance with an embodiment of the present disclosure. The view depicts the cell phone C sides and the wrap around exposure of the arms A, the legs L and the ears E of the teddy bear figure which is popable or detachable via the retaining bosses R. The arms A, the legs L, the ears E and portions of the figure including a head and a body are chewable and shock absorbing in three-dimensions including the back, the sides, ends and front of the cell phone case and the cell phone itself.

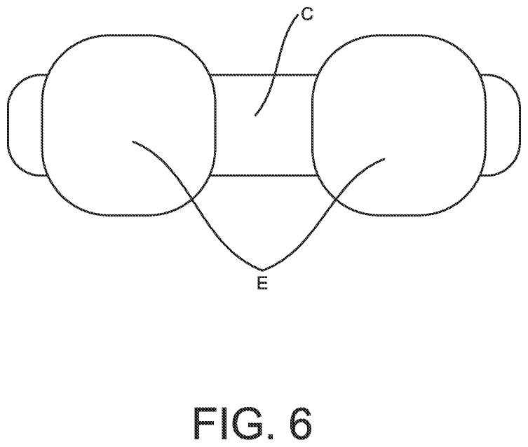

FIG. 6 is an end view of the baby bear teether phone case in accordance with an embodiment of the present disclosure. The cell phone case C is exceeded in size and volume by the ears E as seen from the top end and a similar depiction occurs at the bottom end or the foot end adjacent the legs L and the charging port protected by clip F not depicted.

The present disclosed baby teether phone case, also known as “Hello Biters”, offers a modern accessory that works to protect an individual's cell phone or electronic device, as well as provide a safe teething option for the child when the infant finds themselves in possession of said phone. Expanding on the initial design of an average phone case, Hello Biters introduces a novel safe chewable rubber fixed butterfly aesthetic body part with rubber flapping wings which extend from the primary waterproof, chew safe, phone case. Since cell phones are never far away, kids will always have a safe alternative to soothe and distract themselves as opposed to a teether that often gets misplaced. Hello Bitters prevents phone damage caused by teething babies and keeps a teether on hand, at all times; thereby, providing an accessory that not only protects an electronic device but also provides a safe option for babies to chew on for teething support. As a result, this innovative, top-quality product may benefit all parents who seek to have a more easily accessible teether and a more efficient means of protecting their devices.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A cell phone case device comprising:
a cell phone case comprising a back, a front for a cell phone screen, two sides and two ends;
a figure in three-dimensions disposed on the back of the cell phone case configured to provide a child chewable and an absorber to a drop shock thereon;
a side appendage in three-dimensions connected to the figure on each of the two sides to provide a child chewable and an absorber to a drop shock thereon; and
an end appendage in three-dimensions connected to the figure on each of the two ends to provide a child chewable and an absorber to a drop shock thereon.

2. The cell phone case device of claim 1, wherein the three-dimensional figure is a teddy bear.

3. The cell phone case device of claim 1, wherein the side appendages are arms.

4. The cell phone case device of claim 1, wherein the end appendages are legs and a head.

5. The cell phone case device of claim 1, wherein the end appendages are legs and ears.

6. The cell phone case device of claim 1, wherein the three-dimensional figure, the side appendages and the end appendages compose a chewable material for infants.

7. The cell phone case device of claim 1, wherein the side appendages wrap around the two sides of the cell phone case.

8. The cell phone case device of claim 1, wherein the end appendages wrap around the two ends of the cell phone case.

9. The cell phone case device of claim 1, wherein the three-dimensional figure is a butterfly.

10. The cell phone case device of claim 1, wherein the side appendages are wings of a butterfly.

11. The cell phone case device of claim 1, wherein the end appendages are antennae and legs of a butterfly.

12. The cell phone case device of claim 1, further comprising a waterproof clip configured to protect a charging port of a cell phone in the cell phone case.

13. The cell phone case device of claim 1, wherein the side appendages wrap around the cell phone case to provide three-dimensional absorbance to a drop shock on a respective side.

14. The cell phone case device of claim 1, wherein the end appendages wrap around the cell phone case to provide three-dimensional absorbance to a drop shock on a respective end.

15. The cell phone case device of claim 1, wherein the three-dimensional figure pops off the cell phone case via a retaining boss for cleaning.

16. The cell phone case device of claim 1, wherein the three-dimensional figure is drop molded with the cell phone case.
